(19) United States
(12) Patent Application Publication
(10) Pub. No.: US 2023/0150160 A1
(43) Pub. Date: May 18, 2023

(54) CUTTER UNIT AND PRINTER

(71) Applicant: Seiko Instruments Inc., Chiba-shi (JP)

(72) Inventor: Tomohiro MURATA, Chiba-shi (JP)

(21) Appl. No.: 17/980,247

(22) Filed: Nov. 3, 2022

(30) Foreign Application Priority Data
Nov. 12, 2021 (JP) 2021-185211

(51) Int. Cl. B26D 1/38; B41J 11/70

(52) U.S. Cl. CPC B26D 1/385; B41J 11/706

(57) ABSTRACT

A cutter unit configured to cut a recording sheet to be advanced toward a forward side in an advancing direction, includes: a fixed blade, which includes a fixed blade edge, and is provided on a first surface side of the recording sheet; a movable blade including: a movable blade edge opposed to the fixed blade edge in a cutting direction crossing the advancing direction; and a sliding surface, which is provided on a backward side in the advancing direction, and is configured to be slid on the fixed blade; and a rack holder capable of reciprocating along the cutting direction, the rack holder including: a movable blade holder configured to support the movable blade; and an urging member configured to urge the movable blade to the backward side in the advancing direction.

### RELATED APPLICATIONS

This application claims priority to Japanese Patent Application No. 2021-185211, filed Nov. 12, 2021, the entire content of which is incorporated herein by reference.

### BACKGROUND OF THE INVENTION

### 1. Field of the Invention

The present invention relates to a cutter unit and a printer.

### 2. Description of the Related Art

Hitherto, there have been proposed various types of tape printing apparatus including cutting means for cutting an elongated roll sheet over an entire width of the roll sheet. For example, there has been widely known a tape printing apparatus including cutting means for cutting a roll sheet over the entire width of the roll sheet by moving a movable blade in a reciprocating manner in a thickness direction of the roll sheet to slide the movable blade on a fixed blade. This tape printing apparatus can suitably cut the roll sheet through use of an urging member such as a presser bar spring for urging a sliding surface of the movable blade, which is to be slid on the fixed blade, to the fixed blade. For example, as the tape printing apparatus of this type, there has been known an apparatus including a pressing spring configured so as to allow the movable blade to freely reciprocate in a tape thickness direction under a state in which the movable blade is pressed to the fixed blade side.

However, in the movable blade of the tape printing apparatus described above, a surface (front surface) opposite to the sliding surface, which is slid on the fixed blade every time the movable blade is moved in a reciprocating manner, is slid on a part (recessed portion) of the fixed pressing spring, and hence a large sliding load is applied to the movable blade. Accordingly, there has been a problem in that a sliding portion of the movable blade is worn, which may result in shortening a lifetime of the movable blade or reducing durability of a cutting mechanism. Further, as a method of reducing the sliding load, a method of providing, for example, a lubricant or a sleeve between the pressing spring and the movable blade may be employed. However, there has been a problem in that such a method may complicate manufacturing steps, which may result in requiring more time and cost for manufacturing the tape printing apparatus.

Accordingly, in this technical field, there has been a demand for a cutter unit and a printer which are capable of cutting a recording sheet under a state in which a movable blade is pressed to a fixed blade side and reducing a sliding load on the movable blade.

### SUMMARY OF THE INVENTION

According to one embodiment of the present invention, there is provided a cutter unit configured to cut a recording sheet to be advanced toward a forward side in an advancing direction, the cutter unit including: a fixed blade, which includes a fixed blade edge, and is provided on a first surface side of the recording sheet; a movable blade including: a movable blade edge opposed to the fixed blade edge in a cutting direction crossing the advancing direction; and a sliding surface, which is provided on a backward side in the advancing direction, and is configured to be slid on the fixed blade; and a rack holder capable of reciprocating along the cutting direction, the rack holder including: a movable blade holder configured to support the movable blade; and an urging member configured to urge the movable blade to the backward side in the advancing direction.

In the above-mentioned cutter unit according to the one embodiment of the present invention, wherein the urging member includes: a first end to be brought into abutment against the movable blade holder; and a second end to be brought into abutment against the forward side of the movable blade in the advancing direction.

In the above-mentioned cutter unit according to the one embodiment of the present invention, wherein the urging member is a pressurizing spring.

In the above-mentioned cutter unit according to the one embodiment of the present invention, wherein

In the above-mentioned cutter unit according to the one embodiment of the present invention, wherein the movable blade edge of the movable blade is formed into an inverted V shape extending from both ends toward a center portion of the movable blade edge.

In the above-mentioned cutter unit according to the one embodiment of the present invention, wherein the urging member is provided at a center portion of the movable blade.

In the above-mentioned cutter unit according to the one embodiment of the present invention, wherein the movable blade holder includes a plurality of grooves that are formed in a front end surface of the movable blade holder on the forward side, and each have an opening.

According to one embodiment of the present invention, there is provided a printer including: a recording sheet to be advanced toward a forward side in an advancing direction; and a cutter unit configured to cut the recording sheet, the cutter unit including: a fixed blade, which includes a fixed blade edge, and is provided on a first surface side of the recording sheet; a movable blade including: a movable blade edge opposed to the fixed blade edge in a cutting direction crossing the advancing direction; and a sliding surface, which is provided on a backward side in the advancing direction, and is configured to be slid on the fixed blade; and a rack holder capable of reciprocating along the cutting direction, the rack holder including: a movable blade holder configured to hold the movable blade; and an urging member configured to urge the movable blade to the backward side in the advancing direction.

### BRIEF DESCRIPTION OF THE DRAWINGS

FIG. 1 is a front view for illustrating a thermal printer according to one embodiment of the present invention.

FIG. 2 is a side view for illustrating the thermal printer.

FIG. 3 is a side view for illustrating an internal configuration of the thermal printer, and shows a cross section taken along the line I-I of FIG. 1.

FIG. 4 is a side view for illustrating a state in which a rack holder of the thermal printer includes a movable blade.

FIG. 5A is a side view for illustrating the movable blade, a fixed blade, and the rack holder of the thermal printer under a state in which the movable blade is moved away from the fixed blade toward a separation side in a cutting direction.

FIG. 5B is a perspective view for illustrating the state illustrated in FIG. 5A.

FIG. 5C is a perspective view for illustrating a state in which a sliding plate of the rack holder is removed.

FIG. 6A is a side view for illustrating the movable blade, the fixed blade, and the rack holder of the thermal printer under a state in which the movable blade performs cutting on a cutting side in the cutting direction.

FIG. 6B is a perspective view for illustrating the state illustrated in FIG. 6A.

### DETAILED DESCRIPTION OF THE PREFERRED EMBODIMENTS

One embodiment of the present invention is described with reference to FIG. 1 to FIG. 6B. In the following embodiment, description is made of, as an example, a thermal printer that is employed in, for example, a cash register or a portable terminal device and is capable of perform printing on, for example, various kinds of labels, receipts, and tickets. Further, in the embodiment and a modification example described later, in some cases, corresponding components are denoted by the same reference symbols, and description thereof is omitted. In addition, in the following description, an expression for describing relative or absolute arrangement, such as “parallel”, “orthogonal”, “center”, or “coaxial”, refers to not only the arrangement in a strict sense but also a state of being relatively displaced with an angle or distance to the degree that falls within a tolerance or can provide the same function.

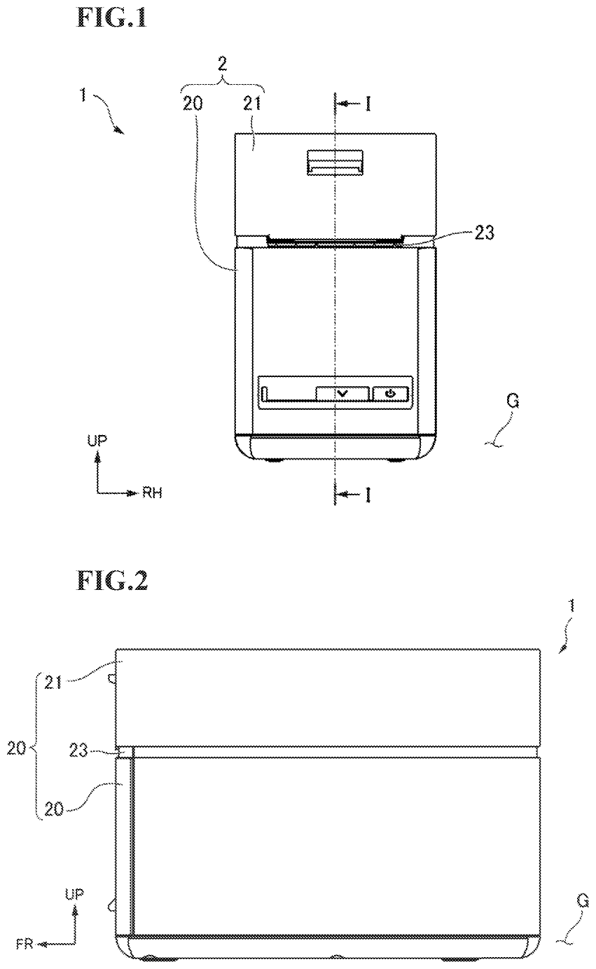

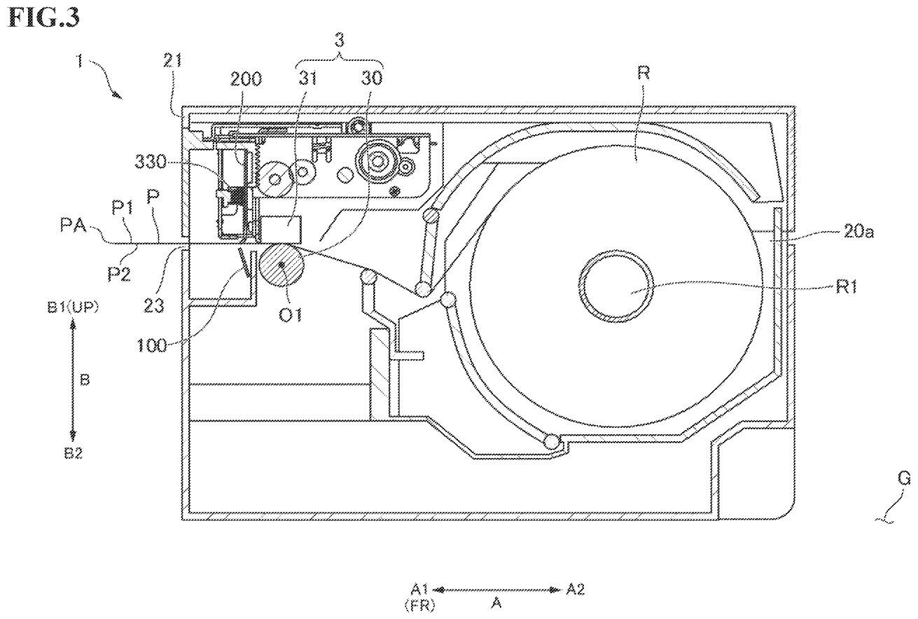

FIG. 1 is a front view for illustrating a thermal printer 1. FIG. 2 is a side view for illustrating the thermal printer 1. FIG. 3 is a sectional view for illustrating an internal configuration of the thermal printer 1, showing a cross section taken along the line I-I of FIG. 1. In the drawings, FR, RH, and UP represent a front side, a right side, and an upper side, respectively. As illustrated in FIG. 3, the thermal printer 1 includes a casing 2, a printing unit 3, a cutter unit 4, and a recording sheet P.

As illustrated in FIG. 1 to FIG. 3, the thermal printer 1 is a printer that performs printing on a print surface P1 (front surface) of the recording sheet P by a thermal head 31 while conveying the recording sheet P through rotation of a platen roller 30, which is to be described later, under a state in which the platen roller 30 and the thermal head 31 sandwich the recording sheet P therebetween. The thermal printer 1 is installed on an installation surface G. In the following description of the casing 2 and the printing unit 3, a direction perpendicular to the installation surface G is referred to as an up-and-down direction (the upper side is indicated by the arrow UP), and two directions orthogonal to the up-and-down direction are referred to as a front-and-back direction (the front side is indicated by the arrow FR) and a right-and-left direction (the right side is indicated by the arrow RH).

As illustrated in FIG. 3, the recording sheet P is a recording sheet to be used for printing by the thermal printer 1. The recording sheet P has the print surface P1 (front surface) formed on a front surface thereof, and has a back surface P2 formed on a side opposite to the print surface P1 in the up-and-down direction. The recording sheet P is rolled up around a tubular core R1 with the print surface P1 facing the front side in the up-and-down direction, and thus forms a roll portion R. The roll portion R may have a configuration without the core R1. A leading edge portion PA of the recording sheet P is drawn to the front side, and is inserted between the thermal head 31 and the platen roller 30. The roll portion R is located inside a housing 20 on a rear side opposite to the front side. When an upper cover 21 is in an opened position, the roll portion R is removed from or loaded into the housing 20 through an upper end opening portion 20a of the housing 20.

The casing 2 is formed into a box shape. Specifically, the casing 2 includes the housing 20 and the upper cover 21.

The housing 20 is formed into a box shape including the upper end opening portion 20a formed in an upper portion of the housing 20, and is installed on the installation surface G. The housing 20 has a size large enough to allow the printing unit 3, the cutter unit 4, and the recording sheet P to be accommodated therein.

The upper cover 21 opens and closes the upper end opening portion 20a of the housing 20. Specifically, the upper cover 21 is formed into a box shape opened downward, and has the same shape as that of the housing 20 in plan view. When the upper cover 21 is in a closed position, the upper cover 21 is superposed on the housing 20 from the upper side to close the upper end opening portion 20a of the housing 20. Further, at this time, a delivery slot 23 is formed between the housing 20 and the upper cover 21. The delivery slot 23 allows communication between an inside and an outside of the casing 2, and has a slit shape extending in the right-and-left direction. The delivery slot 23 allows the recording sheet P having been subjected to printing by the printing unit 3 to be delivered toward the front side. Meanwhile, when the upper cover 21 is in the opened position, the upper cover 21 is retreated from the upper side of the housing 20 to open the upper end opening portion 20a of the housing 20.

As illustrated in FIG. 3, the printing unit 3 includes the platen roller 30 and the thermal head 31.

The platen roller 30 is a rubber roller extending in the right-and-left direction. The platen roller 30 is provided at a front end portion (portion closer to the delivery slot 23) inside the housing 20. The platen roller 30 is rotatable about an axis O1 extending along the right-and-left direction, and is rotated in accordance with a driving force of a driving motor (not shown) during conveyance of the recording sheet P.

The thermal head 31 is provided at a portion closer to the delivery slot 23 inside the upper cover 21. The thermal head 31 includes a plurality of heating elements arrayed in line along the right-and-left direction. The thermal head 31 is fixed to a front end portion of the upper cover 21 with the heating elements facing downward.

The platen roller 30 and the thermal head 31 are opposed to each other in the up-and-down direction while sandwiching the recording sheet P therebetween. When the upper cover 21 is in the closed position, the thermal head 31 is held in close contact with the platen roller 30. The recording sheet P is passed through between the platen roller 30 and the thermal head 31 in accordance with rotation of the platen roller 30. Based on a signal output from a control board (not shown), a heating pattern of the heating elements of the thermal head 31 is controlled. Heat of the heating elements is transferred to the print surface P1 of the recording sheet P, and thus information (such as letters or figures) corresponding to the heating pattern is printed on the print surface P1.

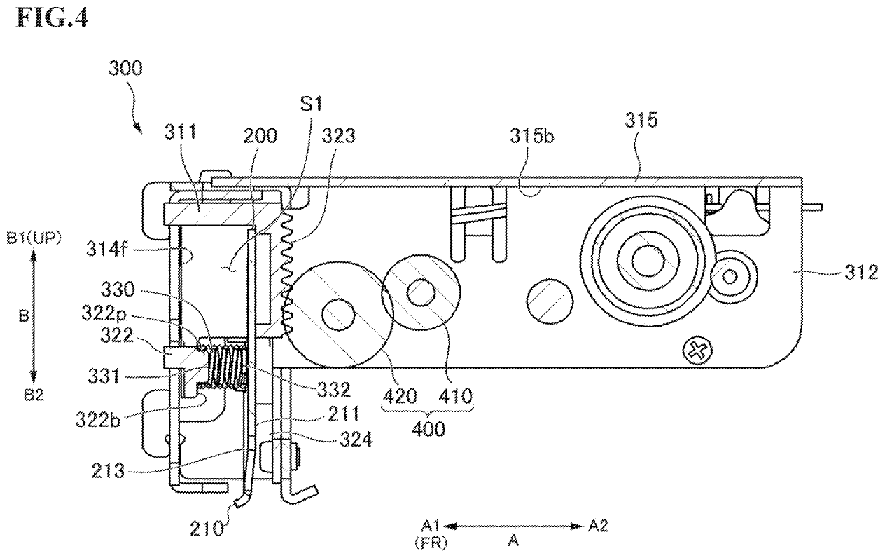

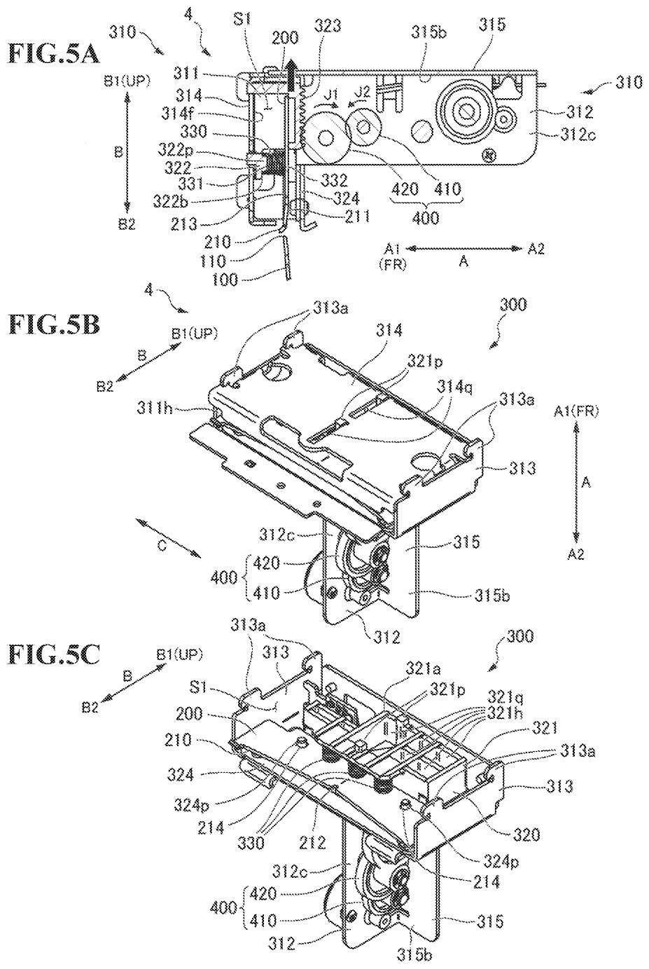

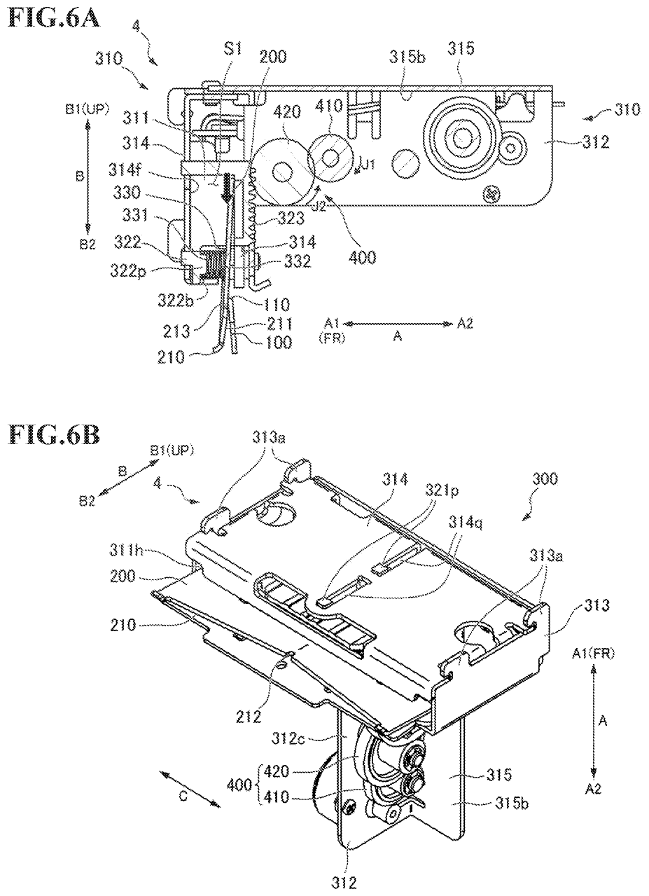

FIG. 4 is a side view for illustrating a state in which a rack holder 300 of the thermal printer 1 includes a movable blade 200. FIG. 5A is a side view for illustrating the movable blade 200, a fixed blade 100, and the rack holder 300 of the thermal printer 1 under a state in which the movable blade is moved away from the fixed blade toward a separation side B1 in a cutting direction B. FIG. 5B is a perspective view for illustrating the state illustrated in FIG. 5A. Further, FIG. 5C is a perspective view for illustrating a state in which a sliding plate 314 of the rack holder 300 is removed. FIG. 6A is a side view for illustrating the movable blade 200, the fixed blade 100, and the rack holder 300 of the thermal printer 1 under a state in which the movable blade performs cutting on a cutting side B2 in the cutting direction B. FIG. 6B is a perspective view for illustrating the state illustrated in FIG. 6A. As illustrated in FIG. 3 to FIGS. 6A and 6B, the cutter unit 4 includes the fixed blade 100, the movable blade 200, the rack holder 300, and a moving mechanism 400.

In the following description of the cutter unit 4, a direction in which the recording sheet P is to be conveyed is referred to as a conveying direction A (advancing direction). In the conveying direction A, a side toward which the recording sheet P is to be conveyed is referred to as a conveyance destination side (forward side) A1, and a side opposite to the conveyance destination side A1 is referred to as a conveyance source side (backward side) A2. Further, a direction of cutting the recording sheet P by the fixed blade 100 and the movable blade 200, which is orthogonal to the conveying direction A, is referred to as the cutting direction B. In the cutting direction B, a side toward which the movable blade 200 is moved away from the fixed blade 100 is referred to as the separation side B1, and a side toward which the movable blade 200 is moved close to the fixed blade 100 to form a rift in the recording sheet P is referred to as the cutting side B2. In addition, a sheet width direction of the recording sheet P orthogonal to the conveying direction A and the cutting direction B is referred to as a width direction C. It is not always required that the cutting direction B be orthogonal to the conveying direction A, and it is only required that the cutting direction B match a direction of cutting the recording sheet P by the fixed blade 100 and the movable blade 200.

In this embodiment, the conveying direction A substantially matches the front-and-back direction. The cutting direction B substantially matches the up-and-down direction. Further, the width direction C substantially matches the right-and-left direction. However, it is not always required that the conveying direction A match the front-and-back direction. It is not always required that the cutting direction B match the up-and-down direction. Further, it is not always required that the width direction C match the right-and-left direction.

As illustrated in FIG. 3, FIG. 5A to FIG. 5C, FIG. 6A, and FIG. 6B, the fixed blade 100 is arranged between the platen roller 30 and the delivery slot 23 in the housing 20. Further, a surface (first surface) of the recording sheet P on the fixed blade 100 side is the back surface P2 of the recording sheet P. The fixed blade 100 is formed into a plate shape extending in the width direction C. The fixed blade 100 is fixed through predetermined means by a support portion (not shown) provided in the housing 20. Further, the fixed blade 100 includes a fixed blade edge 110.

The fixed blade edge 110 is a blade edge of the fixed blade 100 provided on the separation side B1 in the cutting direction B. The fixed blade edge 110 of the fixed blade 100 is slightly moved to the conveyance destination side A1 so that the fixed blade 100 is mounted in an inclined manner.

As illustrated in FIG. 3 to FIG. 6B, the movable blade 200 is arranged between the thermal head 31 and the delivery slot 23 in the upper cover 21. Further, a surface of the recording sheet P on the movable blade 200 side is the print surface P1 of the recording sheet P. In addition, as illustrated in FIG. 6A and FIG. 6B, the movable blade 200 is arranged more on the conveyance destination side A1 than the fixed blade 100 in the conveying direction A when the movable blade 200 is slid on the fixed blade 100. The movable blade 200 is formed into a plate shape extending in the width direction C. Further, the movable blade 200 is held by a movable blade holder 320 provided in the rack holder 300. The movable blade 200 is moved in a reciprocating manner in the cutting direction B by the moving mechanism 400 through intermediation of the movable blade holder 320. Accordingly, the movable blade 200 held by and integrated with the movable blade holder 320 is moved along with movement of the movable blade holder 320. As illustrated in FIG. 3 to FIG. 6B, the movable blade 200 includes a movable blade edge 210, a movable blade sliding surface 211 (sliding surface), an urging member abutment surface 213, and insertion holes 214.

The movable blade edge 210 is a blade edge of the movable blade 200 that forms a rift in the recording sheet P. The movable blade edge 210 is provided on the cutting side B2 of the movable blade 200 in the cutting direction B.

As illustrated in FIG. 5C and FIG. 6B, the movable blade edge 210 of the movable blade 200 is formed into an inverted V shape extending to the separation side B1 in the cutting direction B as extending from both ends toward a center of the movable blade edge 210 in the width direction C. A recessed portion 212 is formed in a center portion of the movable blade edge 210 of the movable blade 200 in the width direction C so as to be recessed to the separation side B1 with respect to the movable blade edge 210.

A bottom of the recessed portion 212 is configured so as to be prevented from being brought into contact with the recording sheet P when the cutter unit 4 cuts the recording sheet P. With this configuration, when the cutter unit 4 cuts the recording sheet P, an uncut portion is formed in a portion of the recording sheet P opposed to the recessed portion 212 (so-called partial cut). In this embodiment, description is made of a configuration in which one recessed portion 212 is formed, and thus one uncut portion is formed (one uncut portion is left), but the present invention is not limited to this configuration. For example, a plurality of recessed portions 212 may be formed, and thus a plurality of uncut portions may be formed (a plurality of uncut portions may be left). The recessed portion 212 is not an essential component.

The movable blade sliding surface 211 (sliding surface) is a surface of the movable blade 200 on the conveyance source side A2, and is slid on the fixed blade edge 110 of the fixed blade 100. The movable blade 200 causes the movable blade sliding surface 211 to slide on the fixed blade edge 110. With this configuration, the movable blade 200 cuts the recording sheet P between the movable blade edge 210 and the fixed blade edge 110. The fixed blade 100 including the fixed blade edge 110 is provided in an inclined manner in the cutter unit 4. Accordingly, the fixed blade edge 110 is reliably brought into abutment against the movable blade sliding surface 211 of the movable blade 200, and thus the recording sheet P can be cut accurately.

The urging member abutment surface 213 is a surface of the movable blade 200 on the conveyance destination side A1. The urging member abutment surface 213 is formed on a side opposite to the movable blade sliding surface 211 in the conveying direction A.

As illustrated in FIG. 5C, the insertion holes 214 are holes formed so as to allow the movable blade 200 to be held on the movable blade holder 320. Two insertion holes 214 pass through the movable blade 200, and are formed in positions closer to both end sides of the movable blade 200 in the width direction C. Through the insertion holes 214, holding protruding portions 324p are inserted when the movable blade 200 is arranged so as to be superposed on a rear holding portion 324 of a movable blade holder main body 321 to be described later from the conveyance destination side A1 toward the conveyance source side A2. The insertion holes 214 are set to be slightly larger than the holding protruding portions 324p.

As illustrated in FIG. 3, the rack holder 300 is arranged on the conveyance destination side A1 of the housing 20 and on the side of the print surface P1 of the recording sheet P. The rack holder 300 has a driving function of moving the movable blade 200 in a reciprocating manner for cutting the recording sheet P having been subjected to printing by the printing unit 3, and a function of holding the movable blade 200. The rack holder 300 includes a rack holder main body 310, the movable blade holder 320, and urging members 330.

As illustrated in FIG. 5A to FIG. 5C, or FIG. 6A and FIG. 6B, the rack holder main body 310 includes a movable blade holder accommodating portion 311 and a moving mechanism mounting portion 312.

The movable blade holder accommodating portion 311 is formed by both side walls 313, the sliding plate 314 provided on the conveyance destination side A1, and an upper plate 315 provided on the conveyance source side A2. Further, the movable blade holder accommodating portion 311 defines a space S1 by the both side walls 313, the sliding plate 314, and the upper plate 315.

The both side walls 313 are provided at both ends of the movable blade holder accommodating portion 311 in the width direction C, respectively. The both side walls 313 each include a plurality of hook portions 313a on the conveyance destination side A1, and hence the both side walls 313 can be hooked on the housing 20. With this configuration, the rack holder 300 can be mounted to the housing 20.

The sliding plate 314 is provided on the conveyance destination side A1 of the movable blade holder accommodating portion 311. The sliding plate 314 includes a sliding surface 314f on the conveyance source side A2. The sliding surface 314f is slid on a front end surface 321a of the movable blade holder main body 321 when the movable blade holder 320 reciprocates along the cutting direction B. Further, the sliding plate 314 includes two guide holes 314q. The two guide holes 314q are formed in center portions of the sliding surface 314f in line in the cutting direction B, and pass through the sliding plate 314. The two guide holes 314q are formed so as to have a larger length in the cutting direction B than that in the width direction C. With the two guide holes 314q, guide protruding portions 321p formed on the movable blade holder 320 are engaged. The guide holes 314q have a function of guiding the rack holder 300 so as to allow the rack holder 300 to move straight in the cutting direction B when the rack holder 300 is moved in a reciprocating manner in the cutting direction B. Further, through adjustment of the lengths of the guide holes 314q in the cutting direction B, movable ranges of the guide protruding portions 321p can be adjusted. Accordingly, the guide holes 314q can limit a movement range of the rack holder 300. In addition, with the above-mentioned configuration, the guide holes 314q can eliminate a risk in that the movable blade 200 held in the rack holder 300 is moved beyond a reciprocating movable range. Further, an end portion of the sliding plate 314 on the cutting side B2 is curved toward the conveyance source side A2, and thus a slight opening, that is, an opening portion 311h is formed in the movable blade holder accommodating portion 311. The opening portion 311h is set to have a width slightly larger than a width of the movable blade 200 in the conveying direction A so as to allow the movable blade 200 to reciprocate in the cutting direction B. The movement range of the rack holder 300 may be controlled with a configuration in which, in addition to the guide holes 314q, for example, a position sensor is provided in the movable blade holder accommodating portion 311, and a movement position of the movable blade 200 is detected with the position sensor.

The upper plate 315 is provided on the separation side B1 of the movable blade holder accommodating portion 311. The upper plate 315 includes a lower surface 315b on the cutting side B2.

As illustrated in FIG. 5A to FIG. 5C, FIG. 6A, and FIG. 6B, the moving mechanism mounting portion 312 is a plate-like member to which the moving mechanism 400 can be mounted. The moving mechanism mounting portion 312 is provided on the lower surface 315b of the upper plate 315. The moving mechanism mounting portion 312 extends along a horizontal plane defined by the conveying direction A and the cutting direction B.

As illustrated in FIG. 5C, the movable blade holder 320 is a holder that moves the movable blade 200 in a reciprocating manner in the cutting direction B while holding the movable blade 200. The movable blade holder 320 includes the movable blade holder main body 321, an urging member holding portion 322, and a rack portion 323. The movable blade holder 320 is accommodated in the space S1 defined in the movable blade holder accommodating portion 311.

The movable blade holder main body 321 is a holder that holds the movable blade 200. The movable blade holder main body 321 includes the two guide protruding portions 321p. The two guide protruding portions 321p are formed on the conveyance destination side A1 of the movable blade holder main body 321 and on the front end surface 321a, which is slid on the sliding plate 314, and extend to the conveyance destination side A1. The guide protruding portions 321p are engaged with the guide holes 314q formed in the sliding plate 314. The movable blade holder main body 321 causes the front end surface 321a to slide on the sliding surface 314f of the sliding plate 314. In order to reduce a sliding load on the sliding plate 314, a plurality of recessed portions 321h (grooves) each having an opening 321q are formed in the front end surface 321a. Further, the movable blade holder main body 321 includes the rear holding portion 324 on a rear side thereof.

The rear holding portion 324 is a plate-like member provided on the conveyance source side A2 of the movable blade holder main body 321 in the conveying direction A. The rear holding portion 324 overlaps the movable blade 200 provided on the conveyance destination side A1. The rear holding portion 324 has a function of holding the movable blade 200. The rear holding portion 324 includes the two holding protruding portions 324p. The two holding protruding portions 324p are formed on the conveyance destination side A1 and on a surface that overlaps the movable blade 200, and extend to the conveyance destination side A1.

As illustrated in FIG. 5C, the holding protruding portions 324p are set to be at substantially the same positions as those of the insertion holes 214 of the movable blade 200 in the width direction C. When the movable blade 200 is arranged from the conveyance destination side A1, the holding protruding portions 324p are inserted through the insertion holes 214 of the movable blade 200. The holding protruding portions 324p slightly project from the insertion holes 214 to the conveyance destination side A1. With this configuration, the movable blade 200 is held on the movable blade holder main body 321. Further, the holding protruding portions 324p are slightly smaller than the insertion holes 214 of the movable blade 200. The holding protruding portions 324p are smaller than the insertion holes 214, and thus can stably hold the movable blade 200 even in a case in which a position of the movable blade 200 is changed in the conveying direction A when the movable blade 200 is moved to the cutting side B2 and brought into abutment against the fixed blade 100.

The urging member holding portion 322 is provided on the conveyance destination side A1 of the movable blade holder 320. The urging member holding portion 322 is formed in a region from a lower end of the movable blade holder 320 to the cutting side B2, extends in the width direction C, and holds the urging members 330 to be described later. The urging member holding portion 322 includes a rear surface 322b on the conveyance source side A2. A first end 331 of each of the urging members 330 is brought into abutment against the rear surface 322b. Further, the rear surface 322b includes urging member holding protruding portions 322p extending to the conveyance source side A2. The urging member holding protruding portions 322p are formed at positions against which the first ends 331 of the urging members 330 are to be brought into abutment. In accordance with the number of the urging members 330, the urging member holding protruding portions 322p of the same number are provided. The urging member holding protruding portions 322p are each set to have substantially the same size as a diameter of an inner periphery of each of the urging members 330 (pressurizing spring), and allow the urging members 330 to be fitted thereto. Accordingly, the urging member holding protruding portions 322p allow the urging members 330 to be easily mounted thereto without the need for, for example, an adhesive. The number of the urging member holding protruding portions 322p is not particularly limited. Further, the first end 331 of each of the urging members 330 may be fixed directly to the rear surface 322b without provision of the urging member holding protruding portions 322p, or the first end 331 may be fixed with, for example, an adhesive.

The rack portion 323 is provided on the conveyance source side A2 of the movable blade holder 320. The rack portion 323 meshes with a second driving gear 420 of the moving mechanism 400 to be described later. When a rotational driving force in one direction is transmitted to the rack portion 323, the rack portion 323 is moved in a reciprocating manner in the cutting direction B. Along with movement of the rack portion 323, as well as the movable blade holder 320, the movable blade 200 and the urging members 330 are moved in a reciprocating manner.

As illustrated in FIG. 4 to FIG. 6B, the moving mechanism 400 is driving means for moving the movable blade 200 in a reciprocating manner. The moving mechanism 400 is mounted to a predetermined position on one surface 312c of the moving mechanism mounting portion 312. The moving mechanism 400 includes the driving motor (not shown), a first driving gear 410, and the second driving gear 420.

The driving motor gives the driving force to the first driving gear 410. The driving force is transmitted to the first driving gear 410 by the driving motor, and thus the first driving gear 410 makes a rotary motion in a first rotation direction J1 in which the first driving gear 410 rotates in one direction, or in a second rotation direction J2 in which the first driving gear 410 rotates in a direction opposite to the first rotation direction J1. The second driving gear 420 is provided between the first driving gear 410 and the rack portion 323. The second driving gear 420 meshes with the first driving gear 410 on the conveyance source side A2, and meshes with the rack portion 323 on the conveyance destination side A1. The rotational driving force is transmitted to the second driving gear 420 from the first driving gear 410. When the first driving gear 410 rotates in the first rotation direction J1, the second driving gear 420 rotates in the second rotation direction J2 opposite to the rotation direction of the first driving gear 410. When the first driving gear 410 rotates in the second rotation direction J2, the second driving gear 420 rotates in the first rotation direction J1 opposite to the rotation direction of the first driving gear 410. When the second driving gear 420 rotates in the second rotation direction J2, the second driving gear 420 transmits the rotational driving force to the rack portion 323, thereby moving the rack portion 323 to the cutting side B2 in the cutting direction B. When the second driving gear 420 rotates in the first rotation direction J1, the second driving gear 420 transmits the rotational driving force to the rack portion 323, thereby moving the rack portion 323 to the separation side B1 in the cutting direction B.

With the above-mentioned configuration, the moving mechanism 400 moves the movable blade 200 in a reciprocating manner with respect to the recording sheet P through intermediation of the movable blade holder 320, and causes the movable blade 200 and the fixed blade 100 to sandwich the recording sheet P therebetween, thereby forming a rift in the recording sheet P. In this embodiment, a movement range of the moving mechanism 400 is limited by the guide holes 314q and the guide protruding portions 321p described above. Accordingly, rotation ranges of the first driving gear 410 and the second driving gear 420 of the moving mechanism 400 are also limited. Owing to provision of the plurality of driving gears, the moving mechanism 400 can easily control an operation at the time of cutting, and can stabilize the cutting operation.

The urging members 330 always urge the movable blade 200 to the fixed blade 100. As the urging members 330, for example, pressurizing springs are used. In this embodiment, the urging members 330 include three pressurizing springs, and are arranged in the same line at substantially equal intervals in the width direction C. Further, the urging members 330 are arranged at such positions as to be prevented from overlapping the holding protruding portions 324p of the rear holding portion 324. The urging members 330 always urge the movable blade 200 to the conveyance source side A2 in the conveying direction A. Accordingly, the fixed blade edge 110 is reliably brought into abutment against the movable blade sliding surface 211 of the movable blade 200, and thus the recording sheet P can be cut accurately. The urging members 330 each include the first end 331 and a second end 332 along the conveying direction A.

The first end 331 is fitted and coupled to the urging member holding protruding portion 322p that is formed on the rear surface 322b of the urging member holding portion 322 provided on the conveyance source side A2 of the movable blade holder main body 321 and extends to the conveyance source side A2.

The second end 332 is brought into press contact with the urging member abutment surface 213 of the movable blade 200. The urging members 330 are provided so as to always apply an urging force to the urging member abutment surface 213 of the movable blade 200 toward the conveyance source side A2 in the conveying direction A, and thus the urging members 330 are prevented from slipping off the rack holder 300.

The urging members 330 are provided so as to apply the urging force to the movable blade 200 arranged more on the conveyance source side A2 than the urging members 330. Regarding a position of each of the urging members 330, it is desired that the urging member 330 be provided at a center of the movable blade 200 in the width direction C. With the arrangement at this position, each of the urging members 330 can reduce a risk in that a cutting failure occurs when the movable blade edge 210 of the movable blade 200 having an inverted V shape cuts the recording sheet P from both ends to a center of the recording sheet P. In this embodiment, three urging members 330 are used, but the number of the urging members 330 is not particularly limited. Further, it is not always required that the urging members 330 be the pressurizing springs, and it is only required that the urging members 330 always apply the urging force to the movable blade 200 toward the conveyance source side A2. Further, a material, a size, a shape, or the number of the urging members 330 is selected as appropriate in accordance with, for example, application and a configuration of the cutter unit 4.

Next, operations of the cutter unit 4 of the above-mentioned thermal printer 1 are described with reference to FIG. 5A to FIG. 5C, FIG. 6A, and FIG. 6B.

FIG. 5A to FIG. 5C are views for illustrating the movable blade 200, the fixed blade 100, and the rack holder 300 of the thermal printer 1 under a state in which the movable blade is moved away from the fixed blade toward the separation side B1 in the cutting direction B. FIG. 6A and FIG. 6B are views for illustrating the movable blade 200, the fixed blade 100, and the rack holder 300 of the thermal printer 1 under a state in which the movable blade performs cutting on the cutting side B2 in the cutting direction B. First, as illustrated in FIG. 6A and FIG. 6B, the first driving gear 410 is rotated in the first rotation direction J1 by the driving force transmitted from the driving motor (not shown). When the first driving gear 410 rotates in the first rotation direction J1, the second driving gear 420, which is provided on the conveyance destination side A1 and meshes with the first driving gear 410, rotates in the second rotation direction J2 opposite to the rotation direction of the first driving gear 410. The rack portion 323 provided in the movable blade holder 320 meshes with the second driving gear 420. When the second driving gear 420 rotates in the second rotation direction J2, the rotational driving force is transmitted to the rack portion 323, and thus the rack portion 323 is moved to the cutting side B2 in the cutting direction B. When the rack portion 323 is moved, the rack holder 300 is moved together with the rack portion 323. The rack holder 300 holds the movable blade 200 through intermediation of the movable blade holder 320, and hence moves the movable blade 200 to the cutting side B2 in the cutting direction B. When the movable blade 200 is moved to the cutting side B2 in the cutting direction B, the movable blade 200 can cut the recording sheet P between the movable blade edge 210 and the fixed blade edge 110. The urging members 330 urge the movable blade 200, and are moved to the cutting side B2 in the cutting direction B along with movement of the rack holder 300. Accordingly, the urging members 330 can always urge the movable blade 200 without being slid on the urging member abutment surface 213 of the movable blade 200.

Next, as illustrated in FIG. 5A to FIG. 5C, by the driving force transmitted from the driving motor (not shown), the first driving gear 410 is rotated in the second rotation direction J2. In this case, the second driving gear 420 rotates in the first rotation direction J1 opposite to the rotation direction of the first driving gear 410. The rack portion 323 provided in the movable blade holder 320 meshes with the second driving gear 420. When the second driving gear 420 rotates in the first rotation direction J1, the rotational driving force is transmitted to the rack portion 323, and the rack portion 323 is moved to the separation side B1 in the cutting direction B. When the rack portion 323 is moved, the rack holder 300 is moved together with the rack portion 323. The rack holder 300 holds the movable blade 200 through intermediation of the movable blade holder 320. Accordingly, the movable blade 200 can be moved to the separation side B1 in the cutting direction B. The urging members 330 urge the movable blade 200, and are moved to the separation side B1 in the cutting direction B along with movement of the rack holder 300. Accordingly, the urging members 330 can always urge the movable blade 200 without being slid on the urging member abutment surface 213 of the movable blade 200.

In this embodiment, the urging members 330 are provided in the rack holder 300, and hence can always urge the movable blade 200. Further, along with movement of the rack holder 300, the movable blade 200 is moved in a reciprocating manner in the cutting direction B together with the urging members 330. Accordingly, the movable blade 200 is not slid on the urging members 330, thereby being capable of reducing the sliding load. Further, the movable blade 200 does not include a portion to be slid on the urging members 330. With this configuration, the movable blade 200 can reduce a fear in that the movable blade 200 is worn due to sliding and generates, for example, abrasion powder.

Further, in this embodiment, the urging members 330 are each arranged at the center of the movable blade 200 in the width direction C. When each of the urging members 330 is arranged at this position, each of the urging members 330 can reduce a risk in that a cutting failure occurs when the movable blade edge 210 of the movable blade 200 having an inverted V shape cuts the recording sheet P from the both ends to the center of the recording sheet P.

Further, in this embodiment, the front end surface 321a of the movable blade holder main body 321 includes the plurality of recessed portions 321h each having the opening 321q. Accordingly, when the movable blade holder main body 321 is slid on the sliding plate 314, sliding portions can be reduced.

Further, in this embodiment, the guide holes 314q of the rack holder 300 have a function of guiding the rack holder 300 so as to allow the rack holder 300 to move straight in the cutting direction B when the rack holder 300 is moved in a reciprocating manner in the cutting direction B. Further, through adjustment of the lengths of the guide holes 314q in the cutting direction B, the movable ranges of the guide protruding portions 321p can be adjusted. Accordingly, the guide holes 314q can limit the movement range of the rack holder 300. In addition, with the above-mentioned configuration, the guide holes 314q can reduce a fear in that the movable blade 200 held in the rack holder 300 is moved beyond the reciprocating movable range.

As described above, in the thermal printer 1 and the cutter unit 4 according to this embodiment, the movable blade 200 can cut the recording sheet P under a state of being pressed toward the fixed blade 100 side, thereby being capable of reducing the sliding load on the movable blade 200.

The present invention is not limited by the one embodiment described above. Further, the components in the one embodiment encompass components easily conceived by a person skilled in the art, or substantially the same components, that is, so-called equivalents. In addition, the components disclosed in the one embodiment can be combined with each other as appropriate.

Hereinabove, the one embodiment of the present invention has been described in detail with reference to the accompanying drawings. However, specific structures of the present invention are not limited to the one embodiment and encompass design modifications and the like without departing from the gist of the present invention. Further, the components described in the one embodiment described above and a modification example described below may be configured in combination with each other as appropriate.

For example, the printer according to the present invention is not limited to the thermal printer 1 illustrated in FIG. 1, and is also applicable to printers having a variety of configurations.

Further, in the above-mentioned embodiment, the fixed blade 100 and the movable blade 200 are arranged under a state in which the first surface being the surface on the fixed blade 100 side is the back surface P2, and the surface on the movable blade 200 side is the print surface P1. However, in the present invention, the arrangement is not particularly limited to such arrangement. For example, the fixed blade 100 and the movable blade 200 may be arranged under a state in which the first surface being the surface on the fixed blade 100 side is the print surface P1, and the surface on the movable blade 200 side is the back surface P2.

Further, in the above-mentioned embodiment, the movable blade 200 is arranged more on the conveyance destination side A1 in the conveying direction A than the fixed blade 100 when being slid on the fixed blade 100. However, in the movable blade of the present invention, for example, a part of the movable blade edge 210 may be arranged more on the conveyance source side A2 than the fixed blade 100.

Further, for example, the urging member 330 that urges the movable blade 200 in the cutting direction B may be formed of an urging member other than the pressurizing spring (for example, a synthetic rubber or a plate spring). In addition, it is not always required that the urging member 330 urge the movable blade 200 to the fixed blade 100 in the conveying direction A. For example, the urging member 330 may be arranged more on the conveyance source side A2 than the movable blade 200, and may be configured to always urge the movable blade 200 to the fixed blade 100 by pulling the movable blade 200.

Further, in the above-mentioned embodiment, description is made of the thermal printer 1 of a so-called cross type in which the movable blade 200 crosses the fixed blade 100, but the present invention is not limited thereto. The present invention is also applicable to printers having a variety of configurations in which the movable blade 200 is moved in a reciprocating manner to cut the recording sheet P.

In any mode described above, according to the cutter unit and the printer of the present invention, the movable blade can cut the recording sheet under a state of being pressed toward the fixed blade side, thereby being capable of reducing the sliding load on the movable blade.

What is claimed is:

1. A cutter unit configured to cut a recording sheet to be advanced toward a forward side in an advancing direction, the cutter unit comprising:
a fixed blade, which includes a fixed blade edge, and is provided on a first surface side of the recording sheet;
a movable blade including:
a movable blade edge opposed to the fixed blade edge in a cutting direction crossing the advancing direction; and
a sliding surface, which is provided on a backward side in the advancing direction, and is configured to be slid on the fixed blade; and
a rack holder capable of reciprocating along the cutting direction, the rack holder including:
a movable blade holder configured to support the movable blade; and
an urging member configured to urge the movable blade to the backward side in the advancing direction.

2. The cutter unit according to claim 1, wherein the urging member includes:
a first end to be brought into abutment against the movable blade holder; and
a second end to be brought into abutment against the forward side of the movable blade in the advancing direction.

3. The cutter unit according to claim 1, wherein the urging member is a pressurizing spring.

4. The cutter unit according to claim 1, wherein the movable blade edge of the movable blade is formed into an inverted V shape extending from both ends toward a center portion of the movable blade edge.

5. The cutter unit according to claim 1, wherein the urging member is provided at a center portion of the movable blade.

6. The cutter unit according to claim 1, wherein the movable blade holder includes a plurality of grooves that are formed in a front end surface of the movable blade holder on the forward side, and each have an opening.

7. A printer, comprising:
a recording sheet to be advanced toward a forward side in an advancing direction; and
a cutter unit configured to cut the recording sheet, the cutter unit including:
a fixed blade, which includes a fixed blade edge, and is provided on a first surface side of the recording sheet;
a movable blade including:
a movable blade edge opposed to the fixed blade edge in a cutting direction crossing the advancing direction; and
a sliding surface, which is provided on a backward side in the advancing direction, and is configured to be slid on the fixed blade; and
a rack holder capable of reciprocating along the cutting direction, the rack holder including:
a movable blade holder configured to hold the movable blade; and
an urging member configured to urge the movable blade to the backward side in the advancing direction.
